(19) United States
(12) Patent Application Publication
(10) Pub. No.: US 2025/0103402 A1
(43) Pub. Date: Mar. 27, 2025

(54) SYSTEM AND METHOD FOR APPLICATION PROGRAMMING INTERFACE COMMUNICATION

(71) Applicant: The Toronto-Dominion Bank, Toronto (CA)

(72) Inventor: Dino Paul D'AGOSTINO, Richmond Hill (CA)

(21) Appl. No.: 18/474,364

(22) Filed: Sep. 26, 2023

(51) Int. Cl. G06F 9/54; H04L 67/104; H04L 67/51

(52) U.S. Cl. CPC G06F 9/541; G06F 9/547; H04L 67/104; H04L 67/51

(57) ABSTRACT

Computing platforms, methods, and storage media for application programming interface communication, for example peer-to-peer API communication, are disclosed. Exemplary implementations may: initiate, at an apparatus, a service request via a peer-to-peer API call from the apparatus to a recipient device; transmit, from the apparatus, a query to the recipient device whether the recipient device is able to fulfill the service request via an API implementation on the recipient device corresponding with an API implementation on the apparatus; receive, at the apparatus, a confirmation from the recipient device that the recipient device is able to fulfill the service request; and initiate completion of a service associated with the service request based on receipt of the confirmation of ability to fulfill the service request.

### FIELD

The present disclosure relates to data communication, including but not limited to computing platforms, methods, and storage media for application programming interface communication.

### BACKGROUND

Software applications running on devices may use an application programming interface (API) to communicate between two applications. An API may include parameters, such as a set of definitions and protocols, for such communication.

In many cases, a third party develops APIs that can be called from a mobile app, in order to perform certain functionality. When a mobile device calls an API, this is typically done via an inter device communication server, such as a web server, to invoke a service that is typically hosted on a server.

Improvements in approaches for application programming interface communication are desirable.

### BRIEF DESCRIPTION OF THE DRAWINGS

Embodiments of the present disclosure will now be described, by way of example only, with reference to the attached Figures.

FIG. 1 illustrates a system configured for peer-to-peer application programming interface communication, in accordance with one or more embodiments.

FIG. 2 illustrates another system configured for peer-to-peer application programming interface communication, in accordance with one or more embodiments.

FIG. 3 illustrates a method for peer-to-peer application programming interface communication, in accordance with one or more embodiments.

FIG. 4 illustrates a system configured for peer-to-peer application programming interface communication between two devices, in accordance with one or more embodiments.

FIG. 5 illustrates a system configured for peer-to-peer application programming interface communication within the same device, in accordance with one or more embodiments.

### DETAILED DESCRIPTION

Computing platforms, methods, and storage media for application programming interface communication, for example peer-to-peer API communication are disclosed. Exemplary implementations may: initiate, at an apparatus, a service request via a peer-to-peer API call from the apparatus to a recipient device; transmit, from the apparatus, a query to the recipient device whether the recipient device is able to fulfill the service request via an API implementation on the recipient device corresponding with an API implementation on the apparatus; receive, at the apparatus, a confirmation from the recipient device that the recipient device is able to fulfill the service request; and initiate completion of a service associated with the service request based on receipt of the confirmation of ability to fulfill the service request.

Embodiments of the present disclosure provide a platform for peer-to-peer discovery, invocation and execution of APIs without needing a central API server.

A technical problem associated with only using services on a central API server is that mobile devices are limited to the available functionality, and cannot leverage potentially different/enhanced functionality available on the mobile devices themselves. Another technical problem is that a central API server acts as a bottleneck for API calls, in addition to limiting the available functionality to only what is available on the central API server. A further technical problem is that existing approaches do not provide the ability to discover API functionality available or to host an API server at a mobile device for peer to peer functionality.

Embodiments of the present disclosure provide a system for provision of API functionality. A peer-to-peer API call between two mobile devices may be used to discover and invoke an API that is running on one of the mobile devices. One mobile device may locally run an API server, which may be discoverable via a service database at an inter device communication service, for example web server. A service daemon on a mobile device may listen for API calls, intercept them, and provide a list of API implementation(s) and location(s) of API server. In an example implementation, a first user may discover an app on a second device associated with a second user, and use that app to initiate sending money to the second user. For example, the first user may invoke an API asking the second user to receive funds, the second user accepts the request, and the transfer is completed after the request has been accepted.

One aspect of the present disclosure relates to a computing platform or apparatus configured for application programming interface communication. The apparatus may include a non-transient computer-readable storage medium having executable instructions embodied thereon. The apparatus may include one or more hardware processors configured to execute the instructions. The processor(s) may execute the instructions to initiate, at an apparatus, a service request via a peer-to-peer API call from the apparatus to a recipient device. The processor(s) may execute the instructions to transmit, from the apparatus, a query to the recipient device whether the recipient device is able to fulfill the service request via an API implementation on the recipient device corresponding with an API implementation on the apparatus. The processor(s) may execute the instructions to receive, at the apparatus, a confirmation from the recipient device that the recipient device is able to fulfill the service request. The processor(s) may execute the instructions to initiate completion of a service associated with the service request based on receipt of the confirmation of ability to fulfill the service request.

Another aspect of the present disclosure relates to a method for application programming interface communication. The method may include initiating, at an apparatus, a service request via a peer-to-peer API call from the apparatus to a recipient device. The method may include transmitting, from the apparatus, a query to the recipient device whether the recipient device is able to fulfill the service request via an API implementation on the recipient device corresponding with an API implementation on the apparatus. The method may include receiving, at the apparatus, a confirmation from the recipient device that the recipient device is able to fulfill the service request. The method may include initiating completion of a service associated with the service request based on receipt of the confirmation of ability to fulfill the service request.

Yet another aspect of the present disclosure relates to a non-transient computer-readable storage medium having instructions embodied thereon, the instructions being executable by one or more processors to perform a method for application programming interface communication. The method may include initiating, at an apparatus, a service request via a peer-to-peer API call from the apparatus to a recipient device. The method may include transmitting, from the apparatus, a query to the recipient device whether the recipient device is able to fulfill the service request via an API implementation on the recipient device corresponding with an API implementation on the apparatus. The method may include receiving, at the apparatus, a confirmation from the recipient device that the recipient device is able to fulfill the service request. The method may include initiating completion of a service associated with the service request based on receipt of the confirmation of ability to fulfill the service request.

A further aspect of the present disclosure relates to a system configured for application programming interface communication. The system may comprise: an initiator mobile device comprising a first API server and a first service daemon; a recipient mobile device comprising a second API server and a second service daemon; and a communication server in communication with the initiator mobile device and the recipient mobile device and comprising a master service daemon configured to discover API server functionality at the initiator mobile device and the recipient mobile device. The initiator mobile device may comprise a non-transient computer-readable storage medium having executable instructions embodied thereon, and one or more hardware processors configured to execute the instructions to: initiate, at the initiator mobile device, a service request via a peer-to-peer API call from the apparatus to the recipient device; transmit, from the initiator mobile device, a query to the recipient device whether the recipient device is able to fulfill the service request via an API implementation on the recipient device corresponding with an API implementation on the apparatus; receive, at the initiator mobile device, a confirmation from recipient device that the recipient device is able to fulfill the service request; and initiate completion of a service associated with the service request based on receipt of the confirmation of ability to fulfill the service request.

A still further aspect of the present disclosure relates to a method of application programming interface communication. The method may comprise: receiving, at a recipient device, a service request via a peer-to-peer API call from an initiating device; receiving, at the recipient device and from the initiating device, a query whether the recipient device is able to fulfill the service request via an API implementation on the recipient device corresponding with an API implementation on the initiating device; and sending, from the recipient device to the initiating device, a confirmation that the recipient device is able to fulfill the service request.

For the purpose of promoting an understanding of the principles of the disclosure, reference will now be made to the features illustrated in the drawings and specific language will be used to describe the same. It will nevertheless be understood that no limitation of the scope of the disclosure is thereby intended. Any alterations and further modifications, and any further applications of the principles of the disclosure as described herein are contemplated as would normally occur to one skilled in the art to which the disclosure relates. It will be apparent to those skilled in the relevant art that some features that are not relevant to the present disclosure may not be shown in the drawings for the sake of clarity.

Certain terms used in this application and their meaning as used in this context are set forth in the description below. To the extent a term used herein is not defined, it should be given the broadest definition persons in the pertinent art have given that term as reflected in at least one printed publication or issued patent. Further, the present processes are not limited by the usage of the terms shown below, as all equivalents, synonyms, new developments and terms or processes that serve the same or a similar purpose are considered to be within the scope of the present disclosure.

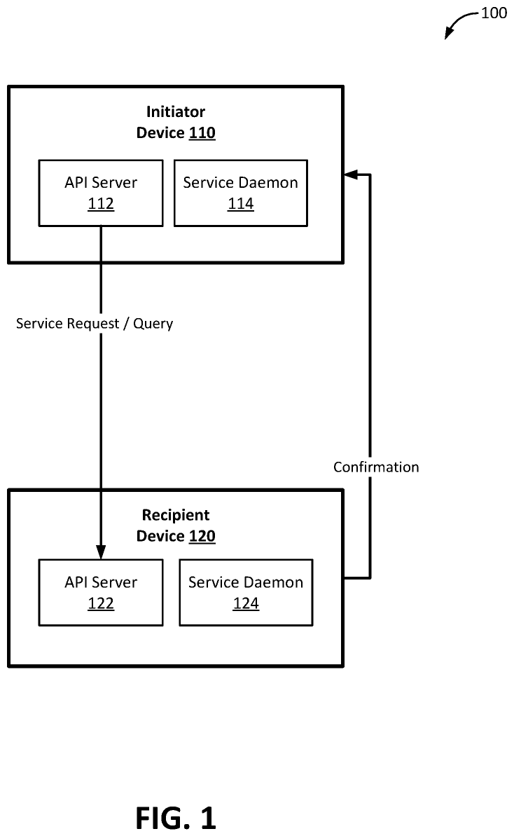

FIG. 1 illustrates a system 100 configured for peer-to-peer application programming interface communication, in accordance with one or more embodiments. The system 100 comprises an initiator device 110 and a recipient device 120. The initiator device 110 comprises an API server 112 and a service daemon 114. The recipient device 120 comprises an API server 122 and a service daemon 124. The initiator device 110 may be associated with a first user and may be distinct from the recipient device 120, and the recipient device 120 may be associated with a second user.

The initiator device 110 may comprise a non-transient computer-readable storage medium having executable instructions embodied thereon, and one or more hardware processors configured to execute instructions to perform a method of API communication. The method may include initiating, at the initiator device 110, a service request via a peer-to-peer API call from the initiator device 110 to the recipient device 120. The method may include transmitting, from the initiator device 110, a query to the recipient device 120 whether the recipient device 120 is able to fulfill the service request via an API implementation on the recipient device, for example the API server 122, corresponding with an API implementation on the apparatus, for example the API server 112. The method may include receiving, at the initiator device 110, a confirmation from the recipient device 120 that the recipient device 120 is able to fulfill the service request. The method may include initiating completion of a service associated with the service request based on receipt of the confirmation of ability to fulfill the service request.

The initiator device 110 may be configured to initiate completion of the service via an API server 122 on the recipient device 120 and independent of a central server. Embodiments of the present disclosure provide an advantage in that API communication can be completed directly between two devices, for example between API servers on each of the devices, and independent of a central server, or any server external to the devices. This enables the devices to communicate with each other in additional ways that are not limited to capabilities of a central server associated with a particular platform or communications network.

The initiator device 110 may be configured to transmit, from the initiator device 110, a service daemon query to check with a service daemon 124 of the recipient device 120 whether the recipient device 120 is able to fulfill the service request. The initiator device 110 may be configured to discover, by the initiator device 110, an application on the recipient device 120 associated with the API implementation 122 that is configured to fulfill the service request, and which may correspond with an API implementation 112 on the initiator device. This discovery aspect enables devices to not only communicate directly with each other, but also to discover additional capabilities of API servers or API implementations provided in the devices, which may not be supported by or available on a platform or communications network with which the devices may otherwise have needed to communicate with each other, such as via a web server. This provides a technical improvement by providing the ability to discover and provide access to additional technical functionality that is available at one or both of the devices in an API communication, when such additional technical functionality is absent from a communication means, such as a web server, that would otherwise need to be used for API communication between the devices.

The initiator device 110 may be configured to transmit a service advertisement advertising services offered by the initiator device 110 that are available to another device via a peer-to-peer API call. Such a service advertisement may, for example, be detected by or used by the recipient device 120 to discover services available at the initiator device 110.

The initiator device 110 may be configured to initiate completion of the service via an application on the recipient device 120 associated with the API implementation 122 that is configured to fulfill the service request. The initiator device 110 may be configured to initiate completion of the service such that the service is initiated at the recipient device 120 and completed at another device.

As mentioned above, the initiator device 110 may be associated with a first user and may be distinct from the recipient device 120, where the recipient device 120 is associated with a second user. In another embodiment, the initiator device 110 and the recipient device 120 may be integral with one another in the same apparatus. In such an embodiment, the initiator device 110 may be configured to: initiate, at a first application at the apparatus, the service request via a peer-to-peer API call from the first application at the apparatus to a second application at the apparatus; transmit, from the first application, the query to the second application whether the second application is able to fulfill the service request via an API implementation at the second application corresponding with an API implementation at the first application; receive, at the first application, a confirmation from the second application that the second application is able to fulfill the service request; and initiate completion of the service associated with the service request based on receipt of the confirmation of ability to fulfill the service request.

Embodiments of the present disclosure provide a method and system configured to use a peer to peer API call between two mobile devices to invoke an API that is running on one of the mobile devices. This is in contrast to known approaches of invoking an API that is running on a central server, such as a web server.

For example, as long as a first user has an application, such as a banking app, running, a second user may invoke an API that is running on the first user's mobile device. In an implementation, an API server is running on a mobile device, such as an iOS device, and the services available on the mobile device may be advertised on a regular basis. The APIs themselves may be implemented in an IOS app itself, and shared in a peer to peer way. In an example implementation, a server may target a specific person's device and gather information about the service, for example using a peer to peer API call, through the communication server.

At a mobile device, a service daemon may be configured to: listen for calls, intercept them, provide list of API implementation and location of API server. As there may be different versions of apps, the mobile device service daemon may communicate back to a master service daemon, which may be implemented at an Inter Device Communication Server (IDCS) such that the master service daemon may be aware at all times of which apps on which devices are currently active. The master service daemon may query all devices in real time, using a standard API, using an inter-process communication (IPC), go to the mobile device service daemon, and provide permission to invoke API implementation, which then calls code from within the API server, and then have access to a secure element, for example an accelerometer, as needed.

Typically for API invocation, it is necessary to call and wait for a response. According to embodiments of the present disclosure, instead the calls go in the opposite way. Apps may communicate directly with each other. For example, Device 2 mobile app 3 may call Device 1 mobile app 1, enabling cross-device app communication. User 2's device may discover services on User 1's device, and not just send a message but invoke an operation. Whenever User 2's device calls User 1's device, they may invoke each other's device's services.

Consider a known approach of sending money. User 2 using Device 2 wants to send money to User 1 using Device 1. In a known approach, User 1 would receive an email indicating that the money was sent, and asking if they want to accept. The money would go from User 1's device, through APIs at a server, and back.

According to embodiments of the present disclosure, User 2's app may discover User 1's app. The discovery may determine whether User 1's device is configured to receive money. User 2 may then send money, for example $100, in an encrypted packet, and invoke an API asking User 1 to receive the $100. This may be performed without a call to a server yet, such that the actual transfer of money may be delayed.

User 1 may receive the $100 encrypted request and accept the request. When the request comes in comes in, an API running on User 1's device may indicate that User 1's device may can accept money as an API call. At that point, User 1's device may make a call to another API to make the actual transfer of money (after the transfer request was accepted). This API call may travel via an IDCS to other APIs. A message may be sent back to User 2's device to say that User 1 has accepted the $100, by invoking a set of APIs.

A drawback of known approaches is that when a user sends money, the recipient is notified after the fact that the money was sent. The recipient has to wait for the money to get transferred, for example going through the Interac e-transfer process. According to embodiments of the present disclosure, a peer-to-peer API call between two devices provides the opportunity and functionality to have the money to go immediately. Known approaches need to use a communications network, such as an Interac e-transfer, even if both the sender and the recipient are at the same bank or financial institution.

Using embodiments of the present disclosure, the recipient is given the opportunity to agree to accept the money, and the transfer would not need to happen over a third-party network such as Interac, but could happen directly between devices associated with the sender and the recipient. This provides a technical improvement over known approaches, as the communication may be performed directly between API instances at two devices, without needing to perform the communication over a third-party network or via a central server. This also provides a technical improvement of enabling such communication between API instances in the absence of a functioning third-party network over which, or a central server via which, communications are typically made. This can be beneficial when a third-party network is either unavailable or not properly operating or reachable for one or both of the devices associated with the sender and the recipient.

Other embodiments provide a peer-to-peer discovery mechanism, in addition to the specific money transfer example above. According to embodiments of the present disclosure, the system does not need to call a central server API, but communication may occur via an IDCS for device security reasons. How APIs are invoked may use a number of different mechanisms such as APNS (push), Google GCM, SMS, email, chat (socketed), etc. Embodiments of the present disclosure provide direct peer-to-peer communication, in contrast to known approaches which invoke a central server API, as opposed to peer-to-peer discovery approach.

According to one or more embodiments, a user may invoke, via a user device, any type of service on another device. For example, if the user wants to get paid in Bitcoin, embodiments of the present disclosure may be used to facilitate a transfer using Bitcoin, which would not be performed via a banking system or other conventional data transfer communications system. For example, a bitcoin wallet application may be running on each of the sender device and the recipient device, with API calls between them.

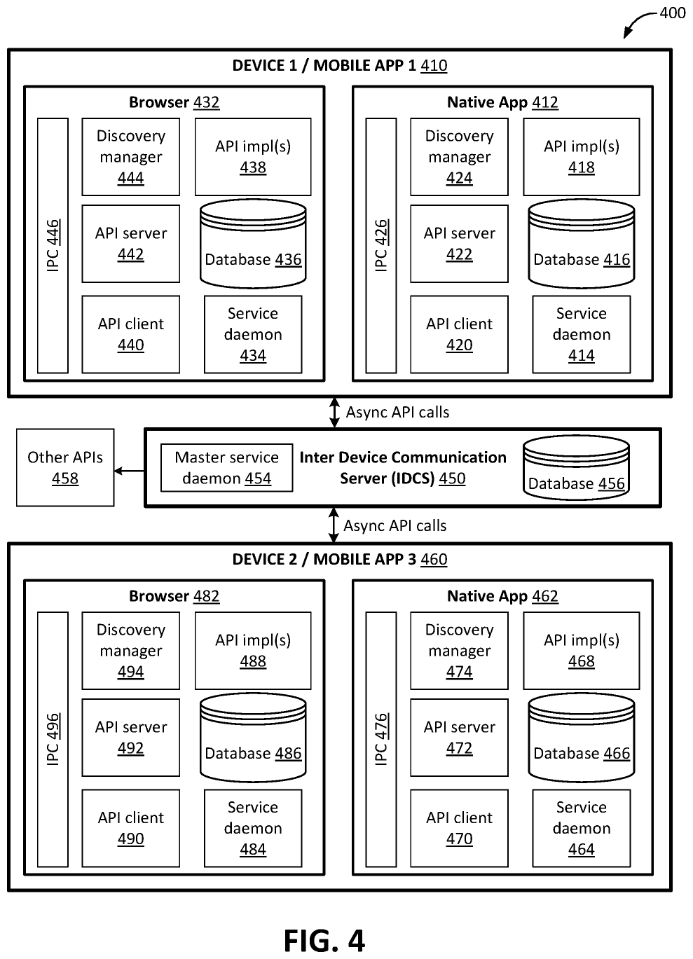

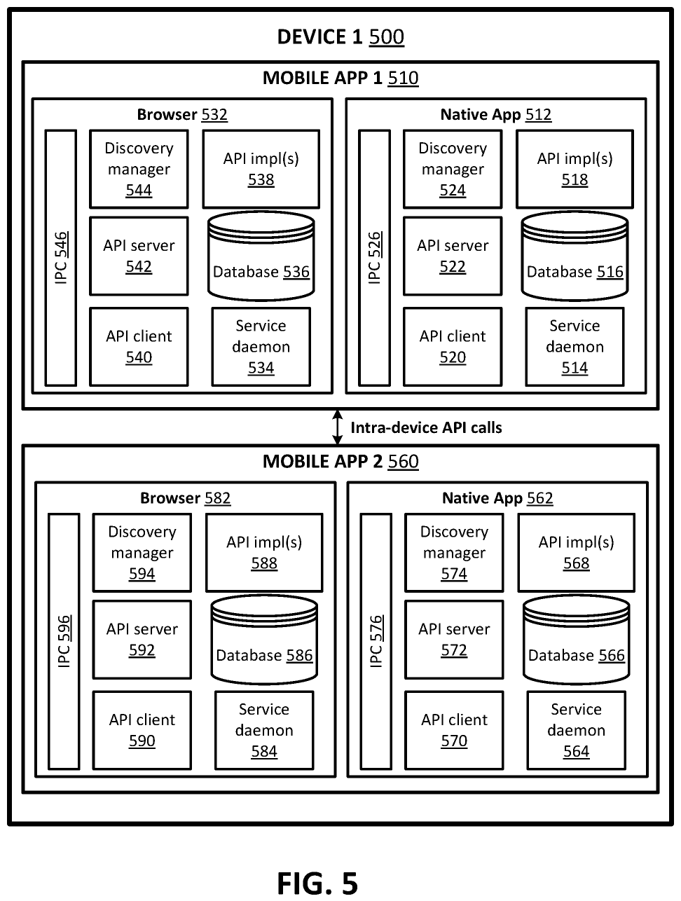

A discovery manager, for example as shown and described later in relation to FIG. 4 and FIG. 5, may be used to discover services available. An API server may be provided at each of a plurality of mobile devices, and a service daemon may be provided to invoke APIs. Embodiments of the present disclosure allow direct communication between two mobile devices to discover available services. A central database of registered devices (and multiple apps) may be kept on IDCS. In an example embodiment, in total 3 databases may be used: central database, and a database on each of the sender and recipient device.

An approach according to embodiments of the present disclosure may cut out or avoid the need for a central or third party API, but the initiator or recipient may choose to invoke other APIs, for example via another party that offers the services. Embodiments of the present disclosure may disintermediate the need for a specific data transfer or payment network, and users may choose a specific network of choice, as well as decide how to send/accept a data transfer. A novel aspect of embodiments of the present disclosure is that APIs at mobile devices are very discoverable, and it is possible to discover a newer version of an existing app.

An aspect of peer-to-peer communication in embodiments of the present disclosure is that the mobile apps on different devices may expose new and interesting services through the IDCS, since they allow the devices to communicate directly, for example via socket server technologies. API implementations in the mobile devices and the corresponding server may be implemented as glorified listeners.

According to an example embodiment, an API that is present on each of two mobile devices is leveraged to provide functionality independent of an external functionality provider. Another example implementation is to make available at a second app functionality that is currently available at a first app, without sharing information outside of the same device.

A method according to an embodiment of the present disclosure may be described as: initiate a service request at an initiator device; check with service daemon of recipient device to see if service request can be fulfilled via an API implementation on the recipient device that corresponds with an API implementation on the initiator device; wait for confirmation from recipient device that service request can be fulfilled; and complete the service based on acceptance of request.

The communication mechanism may be direct communication between the two mobile devices. However, if one user is offline, another mechanism may be used, for example to send an email or push notification, and a push notification, such as a silent push notification, may invoke upon app startup. According to known approaches, API communications have operated according to a client-server model or architecture. There is now a need to discover services that are running on a device, though known approaches do not currently have a way to invoke them. According to an embodiment of the present disclosure, with permission granted and security permissions, a recipient may provide authorization to invoke an API on a device, which is currently not permitted according to known approaches.

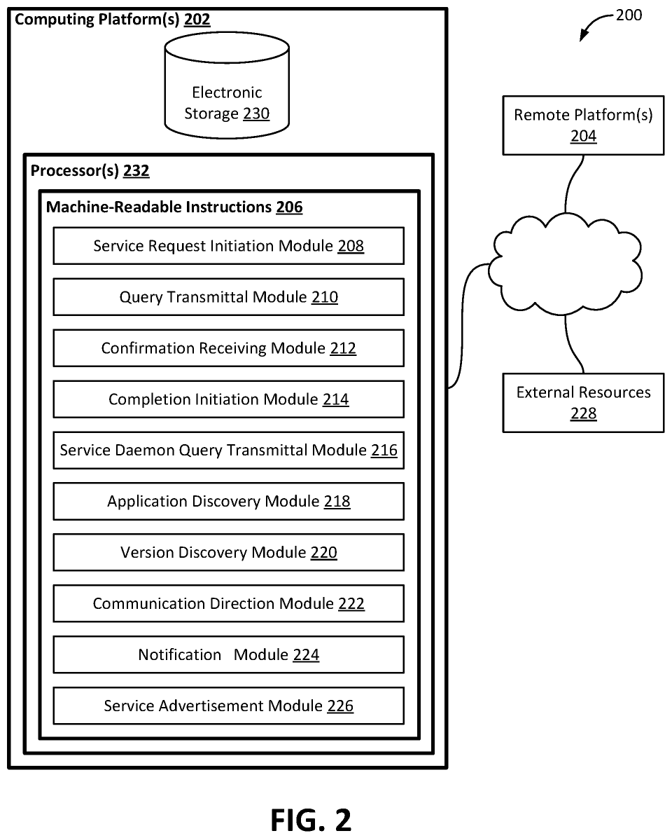

FIG. 2 illustrates a system 200 configured for peer-to-peer application programming interface communication, in accordance with one or more embodiments. In some embodiments, system 200 may include one or more computing platforms 202. Computing platform(s) 202 may be configured to communicate with one or more remote platforms 204 according to a client/server architecture, a peer-to-peer architecture, and/or other architectures. Remote platform(s) 204 may be configured to communicate with other remote platforms via computing platform(s) 202 and/or according to a client/server architecture, a peer-to-peer architecture, and/or other architectures. Users may access system 200 via remote platform(s) 204.

Computing platform(s) 202 may be configured by machine-readable instructions 206. Machine-readable instructions 206 may include one or more instruction modules. The instruction modules may include computer program modules. The instruction modules may include one or more of service request initiation module 208, query transmittal module 210, confirmation receiving module 212, completion initiation module 214, service daemon query transmittal module 216, application discovery module 218, version discovery module 220, communication direction module 222, notification module 224, Service advertisement module 226, and/or other instruction modules.

Service request initiation module 208 may be configured to initiate, at an apparatus, a service request via a peer-to-peer API call from the apparatus to a recipient device. The apparatus may be associated with a first user and may comprise an initiator device distinct from the recipient device, where the recipient device is associated with a second user. In another embodiment, the recipient device may comprise or be integral with the apparatus, such that the peer-to-peer API call is performed within the same device. Service request initiation module 208 may be configured to initiate, at a first application at the apparatus, the service request via a peer-to-peer API call from the first application at the apparatus to a second application at the apparatus.

Query transmittal module 210 may be configured to transmit, from the apparatus, a query to the recipient device whether the recipient device is able to fulfill the service request via an API implementation on the recipient device corresponding with an API implementation on the apparatus. Query transmittal module 210 may be configured to transmit, from the first application, the query to the second application whether the second application is able to fulfill the service request via an API implementation at the second application corresponding with an API implementation at the first application.

Confirmation receiving module 212 may be configured to receive, at the apparatus, a confirmation from the recipient device that the recipient device is able to fulfill the service request. Confirmation receiving module 212 may be configured to receive, at the first application, a confirmation from the second application that the second application is able to fulfill the service request.

Completion initiation module 214 may be configured to initiate completion of a service associated with the service request based on receipt of the confirmation of ability to fulfill the service request. Completion initiation module 214 may be configured to initiate completion of the service via an API server on the recipient device and independent of a central server. Completion initiation module 214 may be configured to initiate completion of the service via an API server on the recipient device and independent of an external service provider. The API server may be discoverable via a service database at an inter device communication service.

Completion initiation module 214 may be configured to initiate completion of the service via an application on the recipient device associated with the API implementation that is configured to fulfill the service request. Completion initiation module 214 may be configured to initiate completion of the service such that the service is initiated at the recipient device and completed at another device. Completion initiation module 214 may be configured to initiate completion of the service associated with the service request based on receipt of the confirmation of ability to fulfill the service request.

Service daemon query transmittal module 216 may be configured to transmit, from the apparatus, a service daemon query to check with a service daemon of the recipient device whether the recipient device is able to fulfill the service request.

Application discovery module 218 may be configured to discover, by the apparatus, an application on the recipient device associated with the API implementation that is configured to fulfill the service request.

Version discovery module 220 may be configured to discover, by the apparatus, a version of an application on the recipient device associated with the API implementation that is configured to fulfill the service request.

Communication direction module 222 may be configured to direct communication between the apparatus and the recipient device via a direct peer-to-peer communication channel when the recipient device appears to the apparatus as being online.

Notification module 224 may be configured to provide a notification from the apparatus to the recipient device when the recipient device appears to the apparatus as being offline.

Service advertisement module 226 may be configured to transmit, by the apparatus, a service advertisement advertising services offered by the apparatus that are available to another device via a peer-to-peer API call.

In some embodiments, computing platform(s) 202, remote platform(s) 204, and/or external resources 228 may be operatively linked via one or more electronic communication links. For example, such electronic communication links may be established, at least in part, via a network such as the Internet and/or other networks. It will be appreciated that this is not intended to be limiting, and that the scope of this disclosure includes implementations in which computing platform(s) 202, remote platform(s) 204, and/or external resources 228 may be operatively linked via some other communication media.

A given remote platform 204 may include one or more processors configured to execute computer program modules. The computer program modules may be configured to enable an expert or user associated with the given remote platform 204 to interface with system 200 and/or external resources 228, and/or provide other functionality attributed herein to remote platform(s) 204. By way of non-limiting example, a given remote platform 204 and/or a given computing platform 202 may include one or more of a server, a desktop computer, a laptop computer, a handheld computer, a tablet computing platform, a NetBook, a Smartphone, a gaming console, and/or other computing platforms.

External resources 228 may include sources of information outside of system 200, external entities participating with system 200, and/or other resources. In some embodiments, some or all of the functionality attributed herein to external resources 228 may be provided by resources included in system 200.

Computing platform(s) 202 may include electronic storage 230, one or more processors 232, and/or other components. Computing platform(s) 202 may include communication lines, or ports to enable the exchange of information with a network and/or other computing platforms. Illustration of computing platform(s) 202 in FIG. 2 is not intended to be limiting. Computing platform(s) 202 may include a plurality of hardware, software, and/or firmware components operating together to provide the functionality attributed herein to computing platform(s) 202. For example, computing platform(s) 202 may be implemented by a cloud of computing platforms operating together as computing platform(s) 202.

Electronic storage 230 may comprise non-transitory storage media that electronically stores information. The electronic storage media of electronic storage 230 may include one or both of system storage that is provided integrally (i.e., substantially non-removable) with computing platform(s) 202 and/or removable storage that is removably connectable to computing platform(s) 202 via, for example, a port (e.g., a USB port, a firewire port, etc.) or a drive (e.g., a disk drive, etc.). Electronic storage 230 may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. Electronic storage 230 may include one or more virtual storage resources (e.g., cloud storage, a virtual private network, and/or other virtual storage resources). Electronic storage 230 may store software algorithms, information determined by processor(s) 232, information received from computing platform(s) 202, information received from remote platform(s) 204, and/or other information that enables computing platform(s) 202 to function as described herein.

Processor(s) 232 may be configured to provide information processing capabilities in computing platform(s) 202. As such, processor(s) 232 may include one or more of a digital processor, an analog processor, a digital circuit designed to process information, an analog circuit designed to process information, a state machine, and/or other mechanisms for electronically processing information. Although processor(s) 232 is shown in FIG. 2 as a single entity, this is for illustrative purposes only. In some embodiments, processor(s) 232 may include a plurality of processing units. These processing units may be physically located within the same device, or processor(s) 232 may represent processing functionality of a plurality of devices operating in coordination. Processor(s) 232 may be configured to execute modules 208, 210, 212, 214, 216, 218, 220, 222, 224, and/or 226, and/or other modules. Processor(s) 232 may be configured to execute modules 208, 210, 212, 214, 216, 218, 220, 222, 224, and/or 226, and/or other modules by software; hardware; firmware; some combination of software, hardware, and/or firmware; and/or other mechanisms for configuring processing capabilities on processor(s) 232. As used herein, the term “module” may refer to any component or set of components that perform the functionality attributed to the module. This may include one or more physical processors during execution of processor readable instructions, the processor readable instructions, circuitry, hardware, storage media, or any other components.

It should be appreciated that although modules 208, 210, 212, 214, 216, 218, 220, 222, 224, and/or 226 are illustrated in FIG. 2 as being implemented within a single processing unit, in embodiments in which processor(s) 232 includes multiple processing units, one or more of modules 208, 210, 212, 214, 216, 218, 220, 222, 224, and/or 226 may be implemented remotely from the other modules. The description of the functionality provided by the different modules 208, 210, 212, 214, 216, 218, 220, 222, 224, and/or 226 described below is for illustrative purposes, and is not intended to be limiting, as any of modules 208, 210, 212, 214, 216, 218, 220, 222, 224, and/or 226 may provide more or less functionality than is described. For example, one or more of modules 208, 210, 212, 214, 216, 218, 220, 222, 224, and/or 226 may be eliminated, and some or all of its functionality may be provided by other ones of modules 208, 210, 212, 214, 216, 218, 220, 222, 224, and/or 226. As another example, processor(s) 232 may be configured to execute one or more additional modules that may perform some or all of the functionality attributed below to one of modules 208, 210, 212, 214, 216, 218, 220, 222, 224, and/or 226.

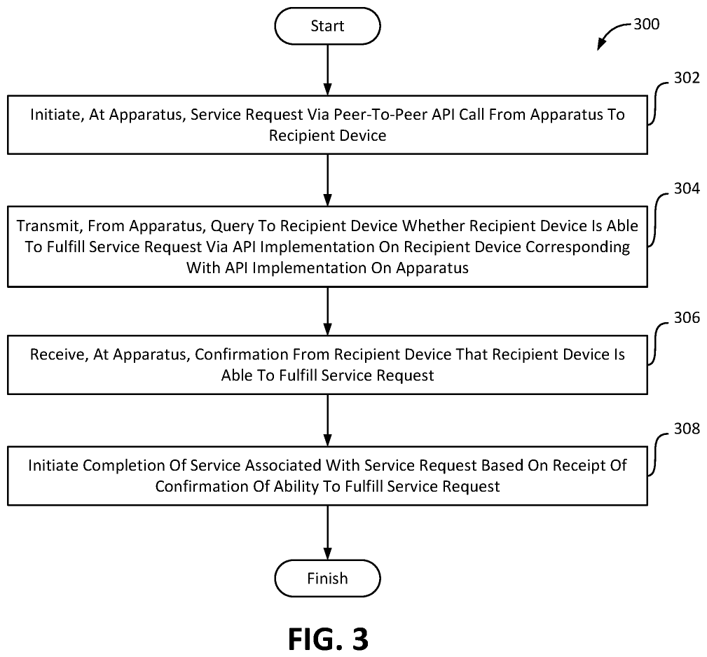

FIG. 3 illustrates a method 300 for peer-to-peer application programming interface communication, in accordance with one or more embodiments. The operations of method 300 presented below are intended to be illustrative. In some embodiments, method 300 may be accomplished with one or more additional operations not described, and/or without one or more of the operations discussed. Additionally, the order in which the operations of method 300 are illustrated in FIG. 3 and described below is not intended to be limiting.

In some embodiments, method 300 may be implemented in one or more processing devices (e.g., a digital processor, an analog processor, a digital circuit designed to process information, an analog circuit designed to process information, a state machine, and/or other mechanisms for electronically processing information). The one or more processing devices may include one or more devices executing some or all of the operations of method 300 in response to instructions stored electronically on an electronic storage medium. The one or more processing devices may include one or more devices configured through hardware, firmware, and/or software to be specifically designed for execution of one or more of the operations of method 300.

An operation 302 may include initiating, at an apparatus, a service request via a peer-to-peer API call from the apparatus to a recipient device. Operation 302 may be performed by one or more hardware processors configured by machine-readable instructions including a module that is the same as or similar to service request initiation module 208, in accordance with one or more embodiments.

An operation 304 may include transmitting, from the apparatus, a query to the recipient device whether the recipient device is able to fulfill the service request via an API implementation on the recipient device corresponding with an API implementation on the apparatus. Operation 304 may be performed by one or more hardware processors configured by machine-readable instructions including a module that is the same as or similar to query transmittal module 210, in accordance with one or more embodiments.

An operation 306 may include receiving, at the apparatus, a confirmation from the recipient device that the recipient device is able to fulfill the service request. Operation 306 may be performed by one or more hardware processors configured by machine-readable instructions including a module that is the same as or similar to confirmation receiving module 212, in accordance with one or more embodiments.

An operation 308 may include initiating completion of a service associated with the service request based on receipt of the confirmation of ability to fulfill the service request. Operation 308 may be performed by one or more hardware processors configured by machine-readable instructions including a module that is the same as or similar to completion initiation module 214, in accordance with one or more embodiments.

FIG. 4 illustrates a system 400 configured for peer-to-peer application programming interface communication between two devices, in accordance with one or more embodiments. The system in FIG. 4 may provide peer-to-peer app discovery and service invocation between mobile devices.

In the embodiment of FIG. 4 Device 1 includes a mobile app 1 410, which may be implemented as a native app 412, such as an iOS or Android app, or implemented as a browser-based app 432, such as an app running in an embedded or external browser. The native app 412 may comprise a service daemon 414, a database 416, one or more API implementations 418, an API client 420, an API server 422, a discovery manager 424 and an inter-process communication (IPC) module 426. Similarly, the browser-based app 432 may comprise a service daemon 434, a database 436, one or more API implementations 438, an API client 440, an API server 442, a discovery manager 444 and an inter-process communication (IPC) module 446. One or more of the browser-based API implementations 438, API client 440, API server 442, and IPC module 446 may be implemented using JavaScript (JS).

In the embodiment of FIG. 4 Device 2 includes a mobile app 3 460, which may be implemented as a native app 462, such as an iOS or Android app, or implemented as a browser-based app 482, such as an app running in an embedded or external browser. The native app 462 may comprise a service daemon 464, a database 466, one or more API implementations 468, an API client 470, an API server 472, a discovery manager 474 and an inter-process communication (IPC) module 476. Similarly, the browser-based app 482 may comprise a service daemon 484, a database 486, one or more API implementations 488, an API client 490, an API server 492, a discovery manager 494 and an inter-process communication (IPC) module 496. One or more of the browser-based one or more API implementations 488, API client 490, API server 492, and IPC module 496 may be implemented using JavaScript (JS).

In the embodiment of FIG. 1, an Inter Device Communication Server (IDCS) 450 is in communication with Device 1 410 and Device 2 460, and comprises a master service daemon 454 and a database 456. Device 1 410 and Device 2 460, and apps running on each of the devices, may communicate via the IDCS 450. In an alternative embodiment, the system may comprise an intra-device communication server.

An API communication process may start with one the service daemon components, which are configured to register and perform network scanning. Devices may initiate a network scanning process to identify other devices and other APIs outside of the devices within their network environment through the IDCS 450 which may act as a repository for current devices. This scanning may be done using various protocols or mechanisms, such as IP-based scanning or broadcasting, UPnP, multi-cast DNS. Devices may actively search for and listen to signals from other devices in their vicinity. The vicinity may be IP based, GPS based, Bluetooth based, RF based or cloud region based.

Each of the service daemons 414, 434, 462 and 486 may advertise the services that it offers. Once a device identifies another device in the network, it may advertise the services or capabilities it offers. This advertisement may include information such as device name, available microservices, supported protocols, and any other relevant metadata. This step allows devices to communicate their capabilities and the resources they can contribute to the network. This may communicate it message structure as well.

Service discovery may occur between service daemons directly, or through the device communication server. Apps on a given device interested in utilizing the services offered by other devices may discover and retrieve the available services. The devices may use standardized protocols like mDNS (Multicast DNS) or UPnP (Universal Plug and Play) and other communications mentioned herein to discover the advertised services on the network. The discovery process typically involves querying the network for specific service types or searching for devices that meet certain criteria through the inter device communication server.

The service daemons may exchange metadata. Once apps on devices discover each other and the available services, they may exchange metadata and establish the necessary communication channels. This metadata exchange may involve negotiation of protocols, authentication/authorization mechanisms, encryption keys, and other relevant information to ensure secure and reliable communication between apps on devices.

An app on a device may communicate with other apps on the same device, with browsers or with other apps on other devices via a peer-to-peer communication such as through the inter device communication server. With device discovery and metadata exchange complete, devices may establish direct peer-to-peer communication channels. These channels may enable devices to exchange data, share resources, and collaborate effectively. Devices may communicate directly with each other without the need for intermediaries or centralized servers.

A service daemon may be responsible for listening on and reacting to calls coming across a given device or across a network. The service daemon may have push listeners, SMS listener, email listener or any other type of listeners that are required. It may listen for deep link API invocations.

The on-device service daemon databases 416, 436, 466 and 486, on the mobile device, in or associated with a native app or an embedded or external browser, may contain an API service definition file in the form of an Interface Definition Language (IDL) such as YAML or gRPC based describing the services provided within this particular app that are invocable/discoverable. Some examples of services include: shut yourself down; start yourself up; reboot the app; invoke calendar/contact list; store or retrieve something from secure storage like a key, etc.

The maser service daemon 454 on the IDCS may be configured to store, for example in the database 456, all of the most current active information of apps across all devices. It may store meta data about those apps such as release date, OS version, app version, services offered/available/discoverable.

FIG. 5 illustrates a system 500 configured for peer-to-peer application programming interface communication within the same device, in accordance with one or more embodiments. The system in FIG. 5 may provide peer-to-peer app discovery and service invocation between apps in the same mobile device.

In the embodiment of FIG. 5 Device 1 500 includes a mobile app 1 510, which may be implemented as a native app 512, such as an iOS or Android app, or implemented as a browser-based app 532, such as an app running in an embedded or external browser. The native app 512 may comprise a service daemon 514, a database 516, one or more API implementations 518, an API client 520, an API server 522, a discovery manager 524 and an inter-process communication (IPC) module 526. Similarly, the browser-based app 532 may comprise a service daemon 534, a database 536, one or more API implementations 538, an API client 540, an API server 542, a discovery manager 544 and an inter-process communication (IPC) module 546. One or more of the browser-based one or more API implementations 538, API client 540, API server 542, and IPC module 546 may be implemented using JavaScript (JS).

In the embodiment of FIG. 1 the same Device 1 also includes a mobile app 2 560, which may be implemented as a native app 562, such as an iOS or Android app, or implemented as a browser-based app 582, such as an app running in an embedded or external browser. The native app 562 may comprise a service daemon 564, a database 566, one or more API implementations 568, an API client 570, an API server 572, a discovery manager 574 and an inter-process communication (IPC) module 576. Similarly, the browser-based app 582 may comprise a service daemon 584, a database 586, one or more API implementations 588, an API client 590, an API server 592, a discovery manager 594 and an inter-process communication (IPC) module 596. One or more of the browser-based one or more API implementations 588, API client 590, API server 592, and IPC module 596 may be implemented using JavaScript (JS).

Communication between mobile apps 510 and 560 may be performed using intra-device API calls. The intra-device API calls may comprise intra-device deep linking, or push-based protocol/SMS/email. In the embodiment of FIG. 5, a communication server as shown in FIG. 4 is not needed, since the two mobile apps are provided on the same device 500. Details regarding the inter-app communication for FIG. 5 are similar to those provided in relation to FIG. 4 above. One difference is that the communication need not go through a communication server, but rather directly between API servers of the apps 510 and 560 on the same device 500. Another difference is that the service discovery can be performed directly between the apps 510 and 560.

Embodiments of the present disclosure solve a technical problem associated with known approaches that only use services on a central API server. In such known approaches, mobile devices are limited to the available functionality on the central API server, and cannot leverage potentially different/enhanced functionality available on the mobile devices themselves. Embodiments of the present disclosure enable peer-to-peer API communication between devices, and between apps on the same device, removing the limit of functionality associated with a central server, and leveraging different/enhanced functionality available on the mobile devices themselves. Such direct peer-to-peer API communication improves functioning of a processor executing or associated with the devices involved in the communication. This reduces the processor load and cost, and reduces the memory required, compared to having to conduct communications via a central API server.

Another technical problem is that a central API server acts as a bottleneck for API calls, in addition to limiting the available functionality to only what is available on the central API server. Embodiments of the present disclosure solve this technical problem by removing the bottleneck at the central API server, improving functioning of a processor executing or associated with the devices involved in the communication. This arrangement avoids processor load and cost associated with the central API server, and simplifies communication using peer-to-peer API communication.

A further technical problem is that existing approaches do not provide the ability to discover API functionality available or to host an API server at a mobile device for peer-to-peer functionality. Embodiments of the present disclosure provide discovery manager functionality, which enables a device and/or an app at a device to discover functionality available at another device reachable via peer-to-peer API communication. Embodiments of the present disclosure also enable a device and/or an app at a device to advertise functionality available at another device reachable via peer-to-peer API communication, so that the advertisement is available to the discovery manager.

The service daemons, databases, API implementations, API clients, API servers, discovery managers and inter-process communication modules cooperate together to improve functioning of a processor executing or associated with execution of the peer-to-peer API communication, by making the processors involved more efficient and eliminating the need to involve a central API server in the process. Such implementations may reduce the processor load and cost, as well as reducing the memory required. Such improvements and solutions to computer problems are also achieved by methods of one or more embodiments described and illustrated herein.

Embodiments of the present disclosure provide a platform for peer-to-peer discovery, invocation and execution of APIs without needing a central API server.

Embodiments of the present disclosure provide a system for provision of API functionality. A peer-to-peer API call between two mobile devices may be used to discover and invoke an API that is running on one of the mobile devices. One mobile device may locally run an API server, which may be discoverable via a service database at an inter device communication service, for example a web server. A service daemon on a mobile device may listen for API calls, intercept them, and provide a list of API implementation and location of API server. In an example implementation, a first user may discover an app on a second device associated with a second user, and use that app to initiate sending money to the second user; for example, the first user may invoke an API asking the second user to receive funds, the second user accepts the request, and the transfer is completed after the request has been accepted.

In the preceding description, for purposes of explanation, numerous details are set forth in order to provide a thorough understanding of the embodiments. However, it will be apparent to one skilled in the art that these specific details are not required. In other instances, well-known electrical structures and circuits are shown in block diagram form in order not to obscure the understanding. For example, specific details are not provided as to whether the embodiments described herein are implemented as a software routine, hardware circuit, firmware, or a combination thereof.

Embodiments of the disclosure can be represented as a computer program product stored in a machine-readable medium (also referred to as a computer-readable medium, a processor-readable medium, or a computer usable medium having a computer-readable program code embodied therein). The machine-readable medium can be any suitable tangible, non-transitory medium, including magnetic, optical, or electrical storage medium including a compact disk read only memory (CD-ROM), digital versatile disk (DVD), Blu-ray Disc Read Only Memory (BD-ROM), memory device (volatile or non-volatile), or similar storage mechanism. The machine-readable medium can contain various sets of instructions, code sequences, configuration information, or other data, which, when executed, cause a processor to perform steps in a method according to an embodiment of the disclosure. Those of ordinary skill in the art will appreciate that other instructions and operations necessary to implement the described implementations can also be stored on the machine-readable medium. The instructions stored on the machine-readable medium can be executed by a processor or other suitable processing device, and can interface with circuitry to perform the described tasks.

The above-described embodiments are intended to be examples only. Alterations, modifications and variations can be effected to the particular embodiments by those of skill in the art without departing from the scope, which is defined solely by the claims appended hereto.

Embodiments of the disclosure can be described with reference to the following clauses, with specific features laid out in the dependent clauses:

One aspect of the present disclosure relates to a system configured for peer-to-peer application programming interface communication. The system may include one or more hardware processors configured by machine-readable instructions. The processor(s) may be configured to initiate, at an apparatus, a service request via a peer-to-peer API call from the apparatus to a recipient device. The processor(s) may be configured to transmit, from the apparatus, a query to the recipient device whether the recipient device is able to fulfill the service request via an API implementation on the recipient device corresponding with an API implementation on the apparatus. The processor(s) may be configured to receive, at the apparatus, a confirmation from the recipient device that the recipient device is able to fulfill the service request. The processor(s) may be configured to initiate completion of a service associated with the service request based on receipt of the confirmation of ability to fulfill the service request.

In some implementations of the system, the processor(s) may be configured to initiate completion of the service via an API server on the recipient device and independent of a central server.

In some implementations of the system, the processor(s) may be configured to initiate completion of the service via an API server on the recipient device and independent of an external service provider.

In some implementations of the system, the API server may be discoverable via a service database at an inter device communication service.

In some implementations of the system, the processor(s) may be configured to transmit, from the apparatus, a service daemon query to check with a service daemon of the recipient device whether the recipient device is able to fulfill the service request.

In some implementations of the system, the processor(s) may be configured to initiate completion of the service via an application on the recipient device associated with the API implementation that is configured to fulfill the service request.

In some implementations of the system, the processor(s) may be configured to discover, by the apparatus, an application on the recipient device associated with the API implementation that is configured to fulfill the service request.

In some implementations of the system, the processor(s) may be configured to discover, by the apparatus, a version of an application on the recipient device associated with the API implementation that is configured to fulfill the service request.

In some implementations of the system, the processor(s) may be configured to initiate completion of the service such that the service is initiated at the recipient device and completed at another device.

In some implementations of the system, the apparatus may be associated with a first user and is distinct from the recipient device. In some implementations of the system, the recipient device may be associated with a second user.

In some implementations of the system, the recipient device may include the apparatus. In some implementations of the system, the processor(s) may be configured to initiate, at a first application at the apparatus, the service request via a peer-to-peer API call from the first application at the apparatus to a second application at the apparatus. In some implementations of the system, the processor(s) may be configured to transmit, from the first application, the query to the second application whether the second application is able to fulfill the service request via an API implementation at the second application corresponding with an API implementation at the first application. In some implementations of the system, the processor(s) may be configured to receive, at the first application, a confirmation from the second application that the second application is able to fulfill the service request. In some implementations of the system, the processor(s) may be configured to initiate completion of the service associated with the service request based on receipt of the confirmation of ability to fulfill the service request.

In some implementations of the system, the processor(s) may be configured to direct communication between the apparatus and the recipient device via a direct peer-to-peer communication channel when the recipient device appears to the apparatus as being online.

In some implementations of the system, the processor(s) may be configured to provide a notification from the apparatus to the recipient device when the recipient device appears to the apparatus as being offline.

In some implementations of the system, the processor(s) may be configured to transmit, by the apparatus, a service advertisement advertising services offered by the apparatus that are available to another device via a peer-to-peer API call.

Another aspect of the present disclosure relates to a method for peer-to-peer application programming interface communication. The method may include initiating, at an apparatus, a service request via a peer-to-peer API call from the apparatus to a recipient device. The method may include transmitting, from the apparatus, a query to the recipient device whether the recipient device is able to fulfill the service request via an API implementation on the recipient device corresponding with an API implementation on the apparatus. The method may include receiving, at the apparatus, a confirmation from the recipient device that the recipient device is able to fulfill the service request. The method may include initiating completion of a service associated with the service request based on receipt of the confirmation of ability to fulfill the service request.

In some implementations of the method, it may include initiating completion of the service via an API server on the recipient device and independent of a central server.

In some implementations of the method, it may include initiating completion of the service via an API server on the recipient device and independent of an external service provider.

In some implementations of the method, the API server may be discoverable via a service database at an inter device communication service.

In some implementations of the method, it may include transmitting, from the apparatus, a service daemon query to check with a service daemon of the recipient device whether the recipient device is able to fulfill the service request.

In some implementations of the method, it may include initiating completion of the service via an application on the recipient device associated with the API implementation that is configured to fulfill the service request.

In some implementations of the method, it may include discovering, by the apparatus, an application on the recipient device associated with the API implementation that is configured to fulfill the service request.

In some implementations of the method, it may include discovering, by the apparatus, a version of an application on the recipient device associated with the API implementation that is configured to fulfill the service request.

In some implementations of the method, it may include initiating completion of the service such that the service is initiated at the recipient device and completed at another device.

In some implementations of the method, the apparatus may be associated with a first user and is distinct from the recipient device. In some implementations of the method, the recipient device may be associated with a second user.

In some implementations of the method, the recipient device may include the apparatus. In some implementations of the method, it may include initiating, at a first application at the apparatus, the service request via a peer-to-peer API call from the first application at the apparatus to a second application at the apparatus. In some implementations of the method, it may include transmitting, from the first application, the query to the second application whether the second application is able to fulfill the service request via an API implementation at the second application corresponding with an API implementation at the first application. In some implementations of the method, it may include receiving, at the first application, a confirmation from the second application that the second application is able to fulfill the service request. In some implementations of the method, it may include initiating completion of the service associated with the service request based on receipt of the confirmation of ability to fulfill the service request.

In some implementations of the method, it may include further including direct communication between the apparatus and the recipient device via a direct peer-to-peer communication channel when the recipient device appears to the apparatus as being online.

In some implementations of the method, it may include further including providing a notification from the apparatus to the recipient device when the recipient device appears to the apparatus as being offline.

In some implementations of the method, it may include transmitting, by the apparatus, a service advertisement advertising services offered by the apparatus that are available to another device via a peer-to-peer API call.

Yet another aspect of the present disclosure relates to a non-transient computer-readable storage medium having instructions embodied thereon, the instructions being executable by one or more processors to perform a method for peer-to-peer application programming interface communication. The method may include initiating, at an apparatus, a service request via a peer-to-peer API call from the apparatus to a recipient device. The method may include transmitting, from the apparatus, a query to the recipient device whether the recipient device is able to fulfill the service request via an API implementation on the recipient device corresponding with an API implementation on the apparatus. The method may include receiving, at the apparatus, a confirmation from the recipient device that the recipient device is able to fulfill the service request. The method may include initiating completion of a service associated with the service request based on receipt of the confirmation of ability to fulfill the service request.

In some implementations of the computer-readable storage medium, the method may include initiating completion of the service via an API server on the recipient device and independent of a central server.

In some implementations of the computer-readable storage medium, the method may include initiating completion of the service via an API server on the recipient device and independent of an external service provider.

In some implementations of the computer-readable storage medium, the API server may be discoverable via a service database at an inter device communication service.

In some implementations of the computer-readable storage medium, the method may include transmitting, from the apparatus, a service daemon query to check with a service daemon of the recipient device whether the recipient device is able to fulfill the service request.

In some implementations of the computer-readable storage medium, the method may include initiating completion of the service via an application on the recipient device associated with the API implementation that is configured to fulfill the service request.

In some implementations of the computer-readable storage medium, the method may include discovering, by the apparatus, an application on the recipient device associated with the API implementation that is configured to fulfill the service request.

In some implementations of the computer-readable storage medium, the method may include discovering, by the apparatus, a version of an application on the recipient device associated with the API implementation that is configured to fulfill the service request.

In some implementations of the computer-readable storage medium, the method may include initiating completion of the service such that the service is initiated at the recipient device and completed at another device.

In some implementations of the computer-readable storage medium, the apparatus may be associated with a first user and is distinct from the recipient device. In some implementations of the computer-readable storage medium, the recipient device may be associated with a second user.

In some implementations of the computer-readable storage medium, the recipient device may include the apparatus. In some implementations of the computer-readable storage medium, the method may include initiating, at a first application at the apparatus, the service request via a peer-to-peer API call from the first application at the apparatus to a second application at the apparatus. In some implementations of the computer-readable storage medium, the method may include transmitting, from the first application, the query to the second application whether the second application is able to fulfill the service request via an API implementation at the second application corresponding with an API implementation at the first application. In some implementations of the computer-readable storage medium, the method may include receiving, at the first application, a confirmation from the second application that the second application is able to fulfill the service request. In some implementations of the computer-readable storage medium, the method may include initiating completion of the service associated with the service request based on receipt of the confirmation of ability to fulfill the service request.

In some implementations of the computer-readable storage medium, the method may include further including direct communication between the apparatus and the recipient device via a direct peer-to-peer communication channel when the recipient device appears to the apparatus as being online.

In some implementations of the computer-readable storage medium, the method may include further including providing a notification from the apparatus to the recipient device when the recipient device appears to the apparatus as being offline.

In some implementations of the computer-readable storage medium, the method may include transmitting, by the apparatus, a service advertisement advertising services offered by the apparatus that are available to another device via a peer-to-peer API call.

Still another aspect of the present disclosure relates to a system configured for peer-to-peer application programming interface communication. The system may include means for initiating, at an apparatus, a service request via a peer-to-peer API call from the apparatus to a recipient device. The system may include means for transmitting, from the apparatus, a query to the recipient device whether the recipient device is able to fulfill the service request via an API implementation on the recipient device corresponding with an API implementation on the apparatus. The system may include means for receiving, at the apparatus, a confirmation from the recipient device that the recipient device is able to fulfill the service request. The system may include means for initiating completion of a service associated with the service request based on receipt of the confirmation of ability to fulfill the service request.

In some implementations of the system, the system may include means for initiating completion of the service via an API server on the recipient device and independent of a central server.

In some implementations of the system, the system may include means for initiating completion of the service via an API server on the recipient device and independent of an external service provider.

In some implementations of the system, the API server may be discoverable via a service database at an inter device communication service.

In some implementations of the system, the system may include means for transmitting, from the apparatus, a service daemon query to check with a service daemon of the recipient device whether the recipient device is able to fulfill the service request.

In some implementations of the system, the system may include means for initiating completion of the service via an application on the recipient device associated with the API implementation that is configured to fulfill the service request.

In some implementations of the system, the system may include means for discovering, by the apparatus, an application on the recipient device associated with the API implementation that is configured to fulfill the service request.

In some implementations of the system, the system may include means for discovering, by the apparatus, a version of an application on the recipient device associated with the API implementation that is configured to fulfill the service request.

In some implementations of the system, the system may include means for initiating completion of the service such that the service is initiated at the recipient device and completed at another device.

In some implementations of the system, the apparatus may be associated with a first user and is distinct from the recipient device. In some implementations of the system, the recipient device may be associated with a second user.

In some implementations of the system, the recipient device may include the apparatus. In some implementations of the system, the system may include means for initiating, at a first application at the apparatus, the service request via a peer-to-peer API call from the first application at the apparatus to a second application at the apparatus. In some implementations of the system, the system may include means for transmitting, from the first application, the query to the second application whether the second application is able to fulfill the service request via an API implementation at the second application corresponding with an API implementation at the first application. In some implementations of the system, the system may include means for receiving, at the first application, a confirmation from the second application that the second application is able to fulfill the service request. In some implementations of the system, the system may include means for initiating completion of the service associated with the service request based on receipt of the confirmation of ability to fulfill the service request.

In some implementations of the system, the system may include means for further including direct communication between the apparatus and the recipient device via a direct peer-to-peer communication channel when the recipient device appears to the apparatus as being online.

In some implementations of the system, the system may include means for further including providing a notification from the apparatus to the recipient device when the recipient device appears to the apparatus as being offline.

In some implementations of the system, the system may include means for transmitting, by the apparatus, a service advertisement advertising services offered by the apparatus that are available to another device via a peer-to-peer API call.

Even another aspect of the present disclosure relates to a computing platform configured for peer-to-peer application programming interface communication. The computing platform may include a non-transient computer-readable storage medium having executable instructions embodied thereon. The computing platform may include one or more hardware processors configured to execute the instructions. The processor(s) may execute the instructions to initiate, at an apparatus, a service request via a peer-to-peer API call from the apparatus to a recipient device. The processor(s) may execute the instructions to transmit, from the apparatus, a query to the recipient device whether the recipient device is able to fulfill the service request via an API implementation on the recipient device corresponding with an API implementation on the apparatus. The processor(s) may execute the instructions to receive, at the apparatus, a confirmation from the recipient device that the recipient device is able to fulfill the service request. The processor(s) may execute the instructions to initiate completion of a service associated with the service request based on receipt of the confirmation of ability to fulfill the service request.

In some implementations of the computing platform, the processor(s) may execute the instructions to initiate completion of the service via an API server on the recipient device and independent of a central server.

In some implementations of the computing platform, the processor(s) may execute the instructions to initiate completion of the service via an API server on the recipient device and independent of an external service provider.

In some implementations of the computing platform, the API server may be discoverable via a service database at an inter device communication service.

In some implementations of the computing platform, the processor(s) may execute the instructions to transmit, from the apparatus, a service daemon query to check with a service daemon of the recipient device whether the recipient device is able to fulfill the service request.

In some implementations of the computing platform, the processor(s) may execute the instructions to initiate completion of the service via an application on the recipient device associated with the API implementation that is configured to fulfill the service request.

In some implementations of the computing platform, the processor(s) may execute the instructions to discover, by the apparatus, an application on the recipient device associated with the API implementation that is configured to fulfill the service request.

In some implementations of the computing platform, the processor(s) may execute the instructions to discover, by the apparatus, a version of an application on the recipient device associated with the API implementation that is configured to fulfill the service request.

In some implementations of the computing platform, the processor(s) may execute the instructions to initiate completion of the service such that the service is initiated at the recipient device and completed at another device.

In some implementations of the computing platform, the apparatus may be associated with a first user and is distinct from the recipient device. In some implementations of the computing platform, the recipient device may be associated with a second user.

In some implementations of the computing platform, the recipient device may include the apparatus. In some implementations of the computing platform, the processor(s) may execute the instructions to initiate, at a first application at the apparatus, the service request via a peer-to-peer API call from the first application at the apparatus to a second application at the apparatus. In some implementations of the computing platform, the processor(s) may execute the instructions to transmit, from the first application, the query to the second application whether the second application is able to fulfill the service request via an API implementation at the second application corresponding with an API implementation at the first application. In some implementations of the computing platform, the processor(s) may execute the instructions to receive, at the first application, a confirmation from the second application that the second application is able to fulfill the service request. In some implementations of the computing platform, the processor(s) may execute the instructions to initiate completion of the service associated with the service request based on receipt of the confirmation of ability to fulfill the service request.

In some implementations of the computing platform, the processor(s) may execute the instructions to direct communication between the apparatus and the recipient device via a direct peer-to-peer communication channel when the recipient device appears to the apparatus as being online.

In some implementations of the computing platform, the processor(s) may execute the instructions to provide a notification from the apparatus to the recipient device when the recipient device appears to the apparatus as being offline.

In some implementations of the computing platform, the processor(s) may execute the instructions to transmit, by the apparatus, a service advertisement advertising services offered by the apparatus that are available to another device via a peer-to-peer API call.

What is claimed is:

1. An apparatus for application programming interface (API) communication, the apparatus comprising:
a non-transient computer-readable storage medium having executable instructions embodied thereon; and
one or more hardware processors configured to execute the instructions to:
initiate, at the apparatus, a service request via a peer-to-peer API call from the apparatus to a recipient device;
transmit, from the apparatus, a query to the recipient device whether the recipient device is able to fulfill the service request via an API implementation on the recipient device corresponding with an API implementation on the apparatus;
receive, at the apparatus, a confirmation from the recipient device that the recipient device is able to fulfill the service request; and
initiate completion of a service associated with the service request based on receipt of the confirmation of ability to fulfill the service request.

2. The apparatus of claim 1 wherein the one or more hardware processors are further configured to execute the instructions to:
initiate completion of the service via an API server on the recipient device and independent of a central server.

3. The apparatus of claim 2 wherein the one or more hardware processors are further configured to execute the instructions to:
transmit, from the apparatus, a service daemon query to check with a service daemon of the recipient device whether the recipient device is able to fulfill the service request.

4. The apparatus of claim 2 wherein the one or more hardware processors are further configured to execute the instructions to:
discover, by the apparatus, an application on the recipient device associated with the API implementation that is configured to fulfill the service request.

5. The apparatus of claim 1 wherein the one or more hardware processors are further configured to execute the instructions to:
transmit by the apparatus, a service advertisement advertising services offered by the apparatus that are available to another device via a peer-to-peer API call.

6. The apparatus of claim 1 wherein the one or more hardware processors are further configured to execute the instructions to:
initiate completion of the service via an application on the recipient device associated with the API implementation that is configured to fulfill the service request.

7. The apparatus of claim 1 wherein the one or more hardware processors are further configured to execute the instructions to:
initiate completion of the service such that the service is initiated at the recipient device and completed at another device.

8. The apparatus of claim 1 wherein the apparatus is associated with a first user and is distinct from the recipient device, and the recipient device is associated with a second user.

9. The apparatus of claim 1 wherein the apparatus comprises the recipient device and the method further comprises:
initiating, at a first application at the apparatus, the service request via a peer-to-peer API call from the first application at the apparatus to a second application at the apparatus;
transmitting, from the first application, the query to the second application whether the second application is able to fulfill the service request via an API implementation at the second application corresponding with an API implementation at the first application;
receiving, at the first application, a confirmation from the second application that the second application is able to fulfill the service request; and
initiating completion of the service associated with the service request based on receipt of the confirmation of ability to fulfill the service request.

10. A method of application programming interface (API) communication, the method comprising:
initiating, at an apparatus, a service request via a peer-to-peer API call from the apparatus to a recipient device;
transmitting, from the apparatus, a query to the recipient device whether the recipient device is able to fulfill the service request via an API implementation on the recipient device corresponding with an API implementation on the apparatus;
receiving, at the apparatus, a confirmation from the recipient device that the recipient device is able to fulfill the service request; and
initiating completion of a service associated with the service request based on receipt of the confirmation of ability to fulfill the service request.

11. The method of claim 10 further comprising:
initiating completion of the service via an API server on the recipient device and independent of a central server.

12. The method of claim 11 further comprising:
transmitting, from the apparatus, a service daemon query to check with a service daemon of the recipient device whether the recipient device is able to fulfill the service request.

13. The method of claim 11 further comprising:
discovering, by the apparatus, an application on the recipient device associated with the API implementation that is configured to fulfill the service request.

14. The method of claim 10 further comprising:
transmitting by the apparatus, a service advertisement advertising services offered by the apparatus that are available to another device via a peer-to-peer API call.

15. The method of claim 10 further comprising:
initiating completion of the service via an application on the recipient device associated with the API implementation that is configured to fulfill the service request.

16. The method of claim 10 further comprising:
initiating completion of the service such that the service is initiated at the recipient device and completed at another device.

17. The method of claim 10 further comprising communication between different devices wherein the apparatus is associated with a first user and is distinct from the recipient device, and the recipient device is associated with a second user.

18. The method of claim 10 wherein the apparatus comprises the recipient device and the method further comprises:
initiating, at a first application at the apparatus, the service request via a peer-to-peer API call from the first application at the apparatus to a second application at the apparatus;
transmitting, from the first application, the query to the second application whether the second application is able to fulfill the service request via an API implementation at the second application corresponding with an API implementation at the first application;
receiving, at the first application, a confirmation from the second application that the second application is able to fulfill the service request; and
initiating completion of the service associated with the service request based on receipt of the confirmation of ability to fulfill the service request.

19. A non-transient computer-readable storage medium having instructions embodied thereon, the instructions being executable by one or more processors to perform a method of application programming interface (API) communication, the method comprising:
initiating, at an apparatus, a service request via a peer-to-peer API call from the apparatus to a recipient device;
transmitting, from the apparatus, a query to the recipient device whether the recipient device is able to fulfill the service request via an API implementation on the recipient device corresponding with an API implementation on the apparatus;
receiving, at the apparatus, a confirmation from the recipient device that the recipient device is able to fulfill the service request; and
initiating completion of a service associated with the service request based on receipt of the confirmation of ability to fulfill the service request.

20. The non-transient computer-readable storage medium of claim 19 wherein the method further comprises:
initiating completion of the service via an API server on the recipient device and independent of a central server.
